(19) United States
(12) Patent Application Publication
(10) Pub. No.: US 2009/0185186 A1
(43) Pub. Date: Jul. 23, 2009

(54) SYSTEMS AND METHODS FOR IMPROVING MEASUREMENT OF LIGHT TRANSMITTANCE THROUGH INK DEPOSITED ON A SUBSTRATE

(75) Inventors: Quanyuan Shang, Saratoga, CA (US); John M. White, Hayward, CA (US)

Correspondence Address: DUGAN & DUGAN, PC, 245 Saw Mill River Road, Suite 309, Hawthorne, NY, 10532, US

(73) Assignee: Applied Materials, Inc., Santa Clara, CA (US)

(21) Appl. No.: 12/329,587

(22) Filed: Dec. 6, 2008

Related U.S. Application Data
(60) Provisional application No. 61/012,052, filed on Dec. 6, 2007.

(51) Int. Cl. G01N 21/00

(52) U.S. Cl. 356/432

(57) ABSTRACT

Systems, methods and apparatus for manufacturing color filters for flat panel displays are provided that include an inkjet printing system integrated with a light transmittance measurement system. The inkjet printing system includes a stage for supporting and moving a substrate past inkjet print heads adapted to deposit ink in pixel wells on the substrate. The light transmittance measurement system includes a sensor and a light source disposed on opposite sides of the substrate and adapted to determine the thickness of the ink deposited on the substrate. The light source is adapted to move with the sensor to allow different pixel wells containing deposited ink to be measured, and the stage includes at least one optical path to allow light from the light source to pass through the deposited ink to the sensor.

The present application claims priority from the following U.S. Provisional Patent Application, which is hereby incorporated by reference herein in its entirety:

U.S. Provisional Patent Application Ser. No. 61/012,052, filed Dec. 6, 2007, entitled “SYSTEMS AND METHODS FOR IMPROVING MEASUREMENT OF LIGHT TRANSMITTANCE THROUGH INK DEPOSITED ON A SUBSTRATE” (Attorney Docket No. 12767/L).

### CROSS-REFERENCE TO RELATED APPLICATIONS

This application is related to U.S. Provisional Patent Application Ser. No. 61/012,048, filed Dec. 6, 2007, and entitled “METHODS AND APPARATUS FOR MEASURING DEPOSITED INK IN A SUBSTRATE USING A LINE SCAN CAMERA” (Attorney Docket No. 12812/L);

U.S. patent application Ser. No. ______, filed Dec. 6, 2008, and entitled “METHODS AND APPARATUS FOR MEASURING DEPOSITED INK IN PIXEL WELLS ON A SUBSTRATE USING A LINE SCAN CAMERA” (Attorney Docket No. 12812); and

U.S. patent application Ser. No. 11/758,631 filed Jun. 5, 2007 and entitled “SYSTEMS AND METHODS FOR CALIBRATING INKJET PRINT HEAD NOZZLES USING LIGHT TRANSMITTANCE MEASURED THROUGH DEPOSITED INK” (Attorney Docket No. 11129).

Each of the above patent applications is hereby incorporated by reference herein in its entirety.

### FIELD OF THE INVENTION

The present invention relates generally to inkjet printing of color filters for flat panel displays and more particularly to systems and methods for improving measurement of light transmittance through ink deposited on a substrate.

### BACKGROUND OF THE INVENTION

Flat Panel Displays (FPDs) may be manufactured from substrates that have had differently colored inks jetted onto the substrates to form pixels using printing systems. Light selectively transmitted through the pixels formed on the substrates is used to cause light of a desired color to be emitted by the FPD. For example, a red sub-pixel formed from deposited red ink in a pixel well is used to filter white light transmitted through the sub-pixel so that only red light is emitted. Using a matrix of pixels formed from a combination of differently colored sub-pixels, images may be formed on the display.

The images displayed may be undesirably affected by the quantity or thickness of the ink deposited in the substrate. For example, if a pixel has too much deposited ink, then the color of the light transmitting through the substrate (e.g., color filter) may have a shade of red that is deeper or darker than desired. Such characteristics of the transmitted light may be referred to as light color properties. Accordingly, a portion of the display may display colors differently than other portions of the display. Conversely, if too little ink is deposited in the pixel well then the color may appear less deep (e.g., pale, washed out, etc.) or lighter than desired.

As indicated above, inkjet printing systems may be employed to deposit the ink in the pixel wells. Inkjet printing systems attempt to precisely jet drops of ink into pixel wells from print heads. The drops are typically volumetrically controlled. That is, the print heads include devices that control the volumes of ink that are in each drop of ink that is deposited in the pixel wells. To achieve the desired appearance, a precise and consistent quantity of ink is preferably deposited in the pixel wells. In some cases it may be difficult to quickly and accurately deposit the desired amount of ink in the pixel wells. To achieve and assure such accuracy, methods and systems for accurately measuring the amount of ink deposited are needed.

### SUMMARY OF THE INVENTION

In some aspects, the present invention provides a system for manufacturing color filters for flat panel displays. The invention includes an inkjet printing system including a stage for supporting and moving a substrate past inkjet print heads adapted to deposit ink on the substrate; and a light transmittance measurement system including a camera and a light source disposed on opposite sides of the substrate and adapted to determine the thickness of the ink deposited on the substrate. The light source is adapted to move with the camera to allow different areas of deposited ink to be measured, and the stage includes at least one optical path or opening to allow light from the light source to pass through the deposited ink to the camera.

In some other aspects, the present invention provides a system for manufacturing color filters for flat panel displays that includes an inkjet printing system including a stage for supporting and moving a substrate past inkjet print heads adapted to deposit ink in pixel wells on the substrate; and a light transmittance measurement system including a sensor and a light source disposed on opposite sides of the substrate and adapted to determine the thickness of the ink deposited in the pixel wells on the substrate. The light source is adapted to move with the sensor to allow different pixel wells containing deposited ink to be measured.

In yet other aspects, the present invention provides a method of measuring an amount of ink deposited in a pixel well on a substrate that includes measuring light transmitted through ink deposited in a first pixel well using a light source and a sensor disposed on opposite sides of a substrate; moving the sensor and the light source to a second pixel well without moving the sensor and the light source relative to each other; and measuring light transmitted through the second pixel well.

In still yet other aspects, the present invention provides an apparatus for measuring an amount of ink deposited in a pixel well on a substrate that includes a sensor adapted to measure light transmitted through ink deposited in a pixel well on a substrate; and a coupling adapted to link a first part of the sensor to a second part of the sensor. The coupling is further adapted to maintain a fixed relative position between the first and second parts of the sensor.

In yet other aspects, the present invention provides an apparatus for measuring an amount of ink deposited in a pixel well on a substrate that includes an optical component, wherein the optical component is positioned between a light source and a substrate; a sensor adapted to measure light transmitted from the light source, through the optical component and ink deposited in a pixel well.

Other features and aspects of the present invention will become more fully apparent from the following detailed description, the appended claims, and the accompanying drawings.

### BRIEF DESCRIPTION OF THE DRAWINGS

FIG. 1 depicts a flow chart illustrating an exemplary method of measuring ink deposits in pixel wells using a light source and a camera provided in accordance with embodiments of the present invention.

FIG. 2 depicts a schematic view of an exemplary embodiment of a light transmittance measurement system provided in accordance with embodiments of the present invention.

FIG. 3 depicts a side view of an exemplary embodiment of a light transmittance measurement system provided in accordance with embodiments of the present invention.

FIG. 4 depicts a side view of an exemplary embodiment of a coupled arm light transmittance measurement system provided in accordance with embodiments of the present invention.

FIG. 5 depicts a schematic illustration of a first embodiment of an exemplary optical component provided in accordance with embodiments of the present invention.

FIG. 6 depicts a schematic illustration of a second embodiment of an exemplary optical component provided in accordance with embodiments of the present invention.

FIG. 7 depicts a schematic illustration of a third embodiment of an exemplary optical component provided in accordance with embodiments of the present invention.

FIG. 8 depicts a flow chart illustrating an exemplary method of measuring ink deposits using an optical component in accordance with embodiments of the present invention.

### DETAILED DESCRIPTION

The present invention provides methods, apparatus, and systems for improving the accuracy of light transmittance measurements through ink deposited in pixel wells on a substrate. As used herein, the term “pixel well” is used broadly to include a distinct area on a substrate bounded on at least two sides by pixel matrix walls, areas bounded on all sides by matrix walls, any other areas defined by structures adapted to contain or restrict materials used in displays (e.g., banks for Color Filter on Array and OLED structures), and the like. The amount of light transmitted through deposited ink is directly related to the thickness (and volume) of the ink in a pixel well. The present inventors have determined that the accuracy of deposited ink measurements may be improved by employing a single light source paired with a single sensor or camera when measuring light transmitted through a pixel well. By using a single light source paired with a single camera, the light transmitted through the deposited ink may be more consistent and thus, more accurately measured. According to some embodiments of the present invention, instead of moving a camera among a plurality of light sources, movement of the camera and a single light source may be coordinated so that the two remain aligned with each other. By coordinating the movement, the same light source and the same camera may be used to measure a plurality of deposited ink locations. In an exemplary embodiment, the light source and the camera may be mounted on, e.g., rails disposed on either side of a substrate containing deposited ink. The light source and the camera may be moved along the rails by motors. In some embodiments, the motion of the light source and the camera may happen concurrently. A controller may coordinate the movements to keep the light source aligned with (e.g., directly below) the camera. In some embodiments, a pre-aligned indexing system may be employed to maintain the vertical alignment of the light source and the camera as they are moved. In some embodiments, the system may include an alignment reference that the light source and the camera may be brought to initially. Movement from the alignment reference may be measured to allow precise coordination and maintenance of alignment between the light source and the camera. In some embodiments, the camera may be used to image the light source or a registration reference on the light source, and the image may be used to align the camera and light source.

In some embodiments of the present invention, the camera may be mechanically (e.g., rigidly) coupled to the light source. Such coupling positions the light source stationary relative to the camera during the movements of the light source and camera. That is, the camera and the light source may move from pixel well to pixel well without changing a relative position between the camera and the light source. Thus, the same camera and light source may be employed to measure a plurality of ink deposits in the pixel wells.

In some embodiments, multiple pairs of light sources and cameras may be used concurrently to measure light transmittance through deposited ink in multiple pixel wells concurrently. Such an embodiment may facilitate increased throughput of the deposited ink measurement system. In some embodiments, the deposited ink measurement system may be implemented in an inkjet printing system. One or more cameras may be supported on one or more print bridges or gantries above a substrate supported by a motion stage adapted to move the substrate under the cameras. The cameras may be supported in a manner similar to the way print head assembles are supported such that the cameras may be independently moved along the print bridge. The light sources may be disposed below the motion stage and the stage itself may include one or more windows adapted to allow light from the light sources to be transmitted through the substrate to the cameras. The light sources may be supported on a lower gantry similar to the print bridge such that the light sources may be moved independently of each other but coordinated with a corresponding camera.

In some embodiments, the camera or cameras may be disposed below the substrate and the light source may be disposed above. In some other embodiments, both the light source and the camera may be disposed together above (or below) the stage and, in some cases, a reflective surface may be employed to direct the light back through the substrate to the camera.

By including the deposited ink measurement system integrated into an inkjet printing system, the ink may be deposited on a substrate by the inkjet printing system, and then, without having to remove the substrate from the inkjet printing system (an in some cases while the inkjet system is still printing), the amount of light transmitted through the deposited ink may be measured to determine the thickness of the ink. Therefore the inkjet printing system may be calibrated based upon the determined ink thickness while the substrate remains on the stage and/or while the ink is still being deposited. This “in situ” calibration facilitates efficient processing of the substrate.

As discussed above, light transmitted through deposited ink in a pixel well (ink pixel) may be measured, and this measurement, which may be directly related to the thickness of the deposited ink, may be used to determine the thickness of the deposited ink and the amount of ink deposited in the pixel well. To measure the amount of light transmitted through the filled pixel well, a light source may emit a light beam, or light rays, that may pass through the pixel well and may then be incident on, or received by, a sensor. In some embodiments, the sensor may send the light transmittance information to a controller to be further processed. However, the light rays emitted by the light source may not be uniform in intensity or wavelength when they enter the filled pixel well.

This lack of uniformity may lead to variation in the measured light transmittance, which may negatively impact the accuracy of the determination of the volume of ink in the pixel well, and therefore the determination of whether the nozzles jetting the ink are properly calibrated. In other words, a known quantity of light rays are emitted from a light source and directed at a filled pixel well. The light rays that are transmitted through the filled pixel well are received by the sensor. The received light rays are compared to the known quantity of emitted light rays to determine the amount of measured light transmittance. If the actual emitted light rays directed at the filled pixel well are not the same as the intended emitted light rays due, for example, to light diffusion or e.g., lack of uniformity and/or non-linearity of absorption, the comparison between the received and known quantity of emitted light rights may be inaccurate, and thereby may negatively impact the determination of whether the nozzles jetting the ink are properly calibrated.

In some embodiments the light sources may include optical components adapted to help improve the consistency of the intensity and color (e.g., wavelength range) of the light beam emitted by the light source and used to measure transmittance. Improved consistency allows more accurate measurement results. In some embodiments, the optical component included with the light source may be a light absorbing channel adapted to only pass collimated light traveling straight through the light absorbing channel. The interior of the channel may be colored black and/or made of a light absorbing material. The channel may include two ends, a light source end and an output end, whereby the output end may be positioned opposite to the light source end. Both the light source end and the output end may be solid, and each may have a pinhole, or slit, that allows the light beam to pass from the light source, into the channel, via the pinhole in the light source end, and out of the channel, via the pinhole in the output end. The pinhole in the output end of the channel may be aligned in a parallel fashion with the pinhole in the light source end of the channel, and may thereby allow some of the light to exit the channel. In other words, the light rays emitted by the light source may only pass through the pinhole in the output end of the channel if the light rays are collimated (parallel rays that do not disperse), and the path they follow passes straight through the two pinholes. The light rays that do not pass straight through the pinhole in the output end of the channel may be absorbed by the interior walls of the channel upon contact.

In some embodiments, an optical component included with the light source may be an integrating sphere. The interior of the integrating sphere may be a hollow cavity that is coated or made from a material such that it is highly reflective (e.g., mirrored, white) and may diffuse light. The integrating sphere may include relatively small openings, as needed, for light beam entrance and exit ports. Light rays incident on any point on the inner surface of the integrating sphere are, by multiple scattering reflections, distributed equally to all other such points and the effects of the original direction of such light are minimized. In other words, the light beam may enter the integrating sphere via the light entrance port and may then be reflected about the interior of the integrating sphere until the light beam reaches the exit port. The light beam that exits the integrating sphere may have a relatively uniform intensity over all points of the aperture of the exit port.

In some embodiments of the present invention, the optical component may include one or more color filters, which may correspond to the colors of the deposited ink to be measured. For example, a selected filter may be used to restrict the light from the light source to a desired range of wavelengths, thereby providing a light beam that may be more uniform in intensity and color.

In some embodiments, a filter switching mechanism may be used to select different color filters. A different color filter may be selected based on a desired wavelength, or range of wavelengths, to be restricted and/or transmitted. In some embodiments, different cameras with different filters maybe used for different colored inks. For example, three different black and white cameras, each with a different filter, may be used, one for each color of ink. Likewise, colored CCD cameras may be used, one for each different ink color.

In some embodiments, during a calibration procedure, the system may make a reference measurement for each of the filtered light colors and for a white light reference. The appropriate data may then be correlated with the corresponding measurement of the corresponding colored ink. In this manner, the amount of light transmitted through the pixel wells may be determined relative to the reference measurement. These and other aspects of the present invention are described below with reference to the drawings.

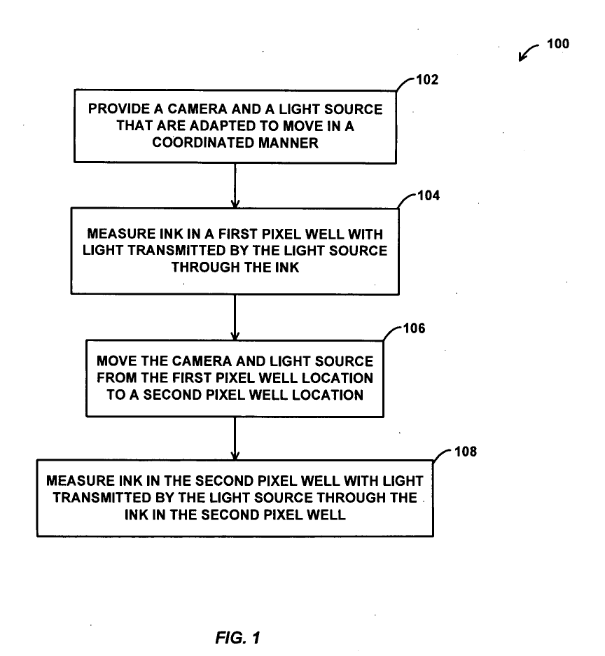

Turing to FIG. 1, a flow chart illustrating an exemplary method 100 of measuring light transmittance through ink deposits is depicted. In step 102, a camera and a light source are provided that are adapted to move in a coordinated manner relative to each other. In some embodiments, motion actuators coupled to the camera and light source may be under the control of a controller, e.g., an inkjet print system controller. In step 104, ink in a first pixel well is measured with light that is transmitted by the light source through the ink. In step 106, the camera and light source are moved, e.g., together, from the first pixel well location to a second pixel well location. In step 108, ink in the second pixel well is measured with light that is transmitted by the light source through the ink in the second pixel well. In some embodiments, the measurements are then related to the thickness of the ink and the inkjet printing system is calibrated using the measurements. Note, that, in some embodiments, a reference measurement may be made of the amount of light that is transmitted through a substrate that does not have deposited ink.

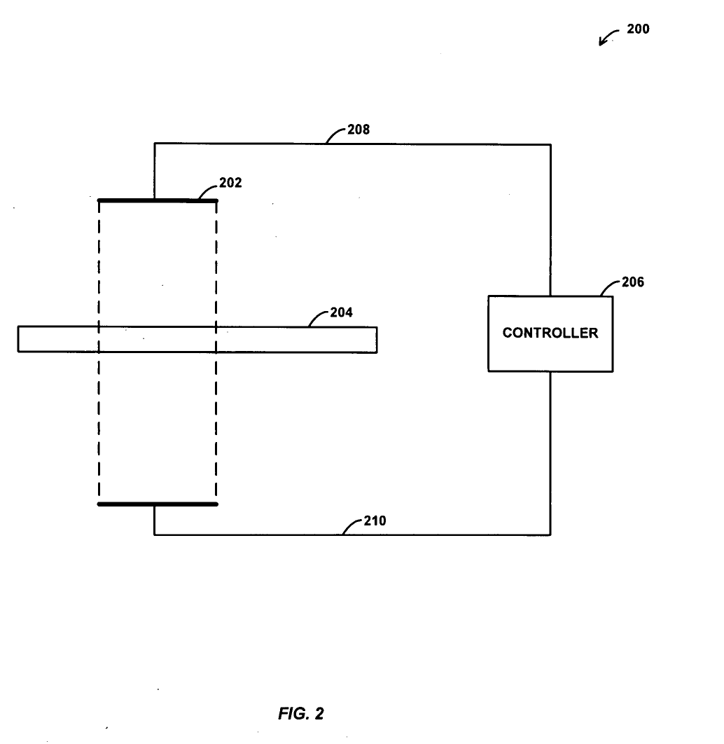

Turning to FIG. 2, a schematic view of an exemplary embodiment of a light transmittance measurement system 200 is depicted. A two part sensor system 202 (e.g., an emitter and detector) transmits and detects light through a substrate 204 upon which ink has been and/or will be deposited. The two part sensor system 202 may function under the direction of a controller 206, which may be coupled to the two part sensor system 202 via channels 208, 210. The two part sensor system 202 may include a source, emitter, and/or transmitter (e.g., light source) disposed on a first side of the substrate 204 and a sensor, detector, and/or meter (e.g., camera) disposed on a second side of the substrate. In some embodiments, both source and detector of the two part sensor system 202 may be disposed on the same side of the substrate 204. In such embodiments, a reflector may be disposed on the other side of the substrate 204 opposite the source and detector. In some embodiments, the stage supporting the substrate 204, and/or the substrate 204 itself, may be used to reflect light (or other radiation) back to the detector for measurement.

In operation, the two part sensor system 202 may be used to measure light transmittance through a first area of the substrate 204 (e.g., through a first pixel well), and then under the direction of the controller 206, the two part sensor system 202 (and/or the substrate 204) may be moved to a second area of the substrate 204 (e.g., a second pixel well) where the two part sensor system 202 may be used to measure light transmittance through the substrate at the second area. In some embodiments, instead of moving the two part sensor system 202 at all, only the substrate 204 is moved. In some embodiments, both the two part sensor system 202 and the substrate 204 my be moved.

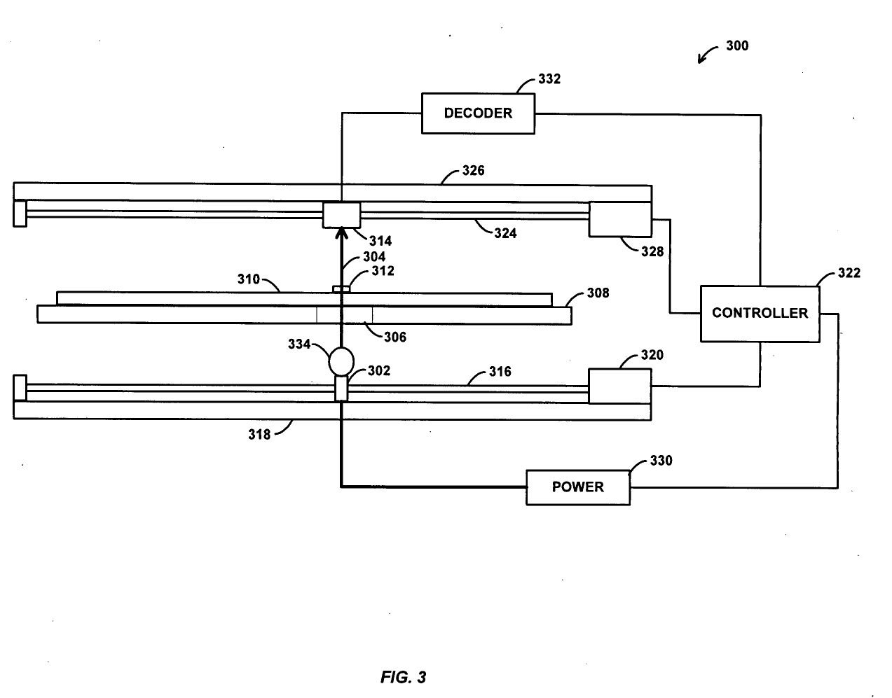

Turning to FIG. 3, a side schematic view of an exemplary embodiment of a light transmittance measurement system 300 is depicted. A light source 302 may be adapted to transmit a light beam 304 through an opening, window, or optical path 306 in a stage 308. The stage 308 may be adapted to support and move a substrate 310, for example, past inkjet print heads (not shown) while ink is deposited on the substrate 310. The light beam 304 may pass through the optical path 306 in the stage 308 to the substrate 310, which is shown as having an ink deposit 312 to be measured. The light beam 304 may pass through the ink deposit 312 to a sensor, e.g., camera 314, where the intensity, level, brightness, or other characteristic may be measured. In some embodiments, the camera 314 may convert the transmitted light beam 304 into signals (e.g., digital signals) that may be used to calculate the thickness of the deposited ink 312.

By including the light transmittance measurement system 300 in an inkjet printing system, the ink may be deposited on the substrate 310, and then, without having to remove the substrate 310 from the inkjet printing system 300, an in situ measurement of the amount of ink deposited may be made. This saves time and allows more accurate measurement of the deposited ink which may include evaporating solvents and thus, have a changing volume.

The deposited ink 312 on the pixel matrix of the substrate 310 may be any suitable ink that is capable of being measured by the transmitted light beam 304. The transmitted light beam 304 may be a white light (e.g., spectrum that appears as a white light to a person) although any suitable spectrum range may be employed. For example, it may be desirable to employ a particular frequency band that is more accurate with a particular CCD array or more suitable for a particular ink formulation or ink color. The transmitted light beam 304 may also be any suitable brightness. For example, it may be desirable that the transmitted light beam 304 is a white light that is about 10 to 1,000,000 cd bright although the light may be more or less bright. The transmitted light beam 304 may be provided by the light source 302. The light source 302 may be a light emitting diode although any suitable light source may be employed. In some embodiments, a laser light source may be used.

The camera 314 may be a charge coupled device (CCD) camera, and may be adapted to receive the transmitted light beam 304. The camera 314 may be a single or multiple pixel CCD camera, though any suitable camera 314 and/or CCD array may be employed. For example, a suitable CCD camera that may be used in the context of the present invention, may include, for example, a 7 um pixel size or smaller, a 2000 pixel count or greater, and an intensity accuracy of 1%, and a 1×1 lens. Other dimensions and parameters may be used. The camera 314 may include electronics that read data. The camera 314 may also include circuits and/or algorithms that filter, integrate, and/or prepare the data read from a CCD array for interpretation. The camera 314 may also include a circuit that is adapted to communicate with other devices and/or computers. For example, the camera 314 may include a Universal Serial Bus (USB) circuit that converts the read data to the USB communication protocol. Thus, another device and/or computer may read the data from the camera 314 for comparison with the other data and/or selected values.

The light source 302 may be moved along a rail 316 supported by a gantry 318. An actuator 320 (e.g., a motor) may be used to move the light source 302 along the rail 316 under the direction of a controller 322. Likewise, the camera 314 may be moved along a rail 324 supported by a print bridge 326. An actuator 328 (e.g., a motor) may be used to move the camera 314 along the rail 324 also under the direction of the controller 322. The light source 302 may receive power from a power supply 330 under the direction of the controller 322. Signals from the camera 314 representative of the light transmittance measurement data may be sent to a decoder 332, wherein the decoder 332 may, for example, determine ink thickness data and communicate the ink thickness data to the controller 322. The ink thickness data may then be used to calibrate the inkjet printing system that may be operated by the controller 322.

Although not shown, additional actuators under the control of the controller 322 may be used to move the stage 308 during both inkjet printing and light transmittance measurement processes. In addition, the rails 316,324 may be moveable in a direction perpendicular to the longitudinal direction of the rails 316,324 to allow motion of the light source 302 and camera 314 to any position above and below the stage 308. Additional actuators under the control of the controller 322 may be used to move the rails 316,324.

In operation, the transmitted light beam 304 may be transmitted through the deposited ink 312 from the light source 302 to the camera 314, for example. The camera 314 may receive the transmitted light beam 304 and convert the transmitted light beam 304 into a signal. For example, the CCD array in the camera 314 may convert the received transmitted light beam 304 into a binary representation of spectrum, intensity, brightness, power, level, amplitude, or any other suitable transmitted light parameter. Such signal may be stored and/or transmitted to the encoder 332, for example.

In operation, the controller 322 may operate the actuators 320, 328 to coordinate motion of the light source 302 and camera 314, respectively. The controller 322 may thus ensure that during a light transmittance measurement, the light source 302 and camera 314 are repeatably and precisely aligned.

As described above, the light beam 304 emitted by the light source 102 may not be uniform in intensity when the light beam 304 passes through the deposited ink 312 and thereafter contacts the camera 314 or sensor. As also described above, the lack of uniformity may lead to variation in the measured light transmittance, which may negatively impact the determination of the volume of ink in the pixel wells and therefore the determination of whether the nozzles jetting the ink are properly calibrated. Therefore, in some embodiments, the light source 302 may include an optical component 334 adapted to help improve the consistency of the intensity and color of the light beam 304 used to measure transmittance, as further described below. The optical component 334 may be a light absorbing channel 500 an integrating sphere 600, a color filter component 700, or other device, for example, described further below. Other suitable optical components including lenses, diffusers, collimators, guides, filters, polarizers, and other devices may be used.

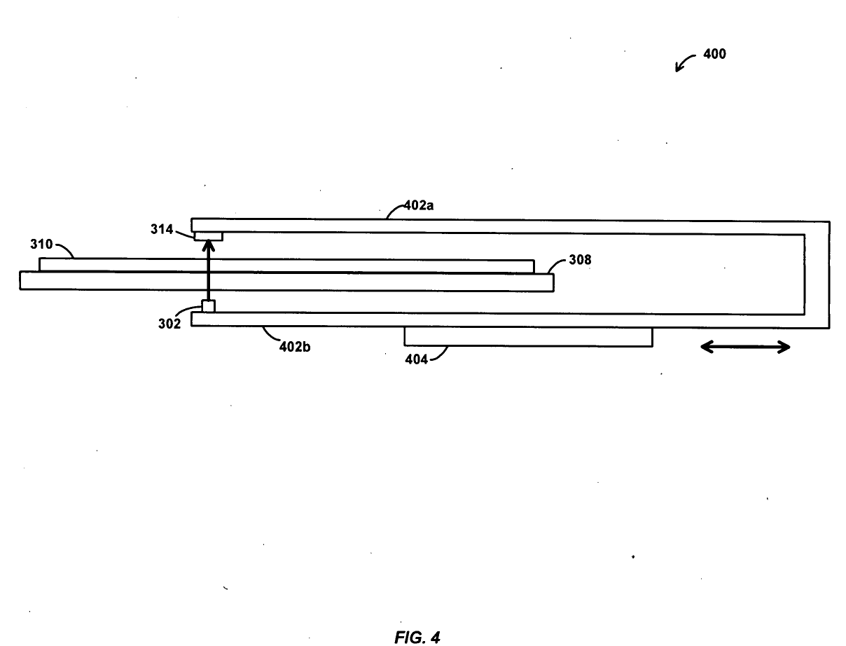

Turning to FIG. 4, a side view of an exemplary embodiment of a coupled arm light transmittance measurement system 400 is depicted. A light source 302 is adapted to transmit a light beam (indicated by the bold unidirectional arrow) through an optical path in a stage 308. The stage 308 is adapted to support and move a substrate 310. For example, the stage 308 may be the motion stage or X-Y table of an inkjet printing system, the end effector of a transfer robot, or the like. The light beam passes through the optical path in the stage 308 to the substrate 310 which may include an ink deposit to be measured. The light beam passes through the ink deposit to a camera 314 where the intensity, level, brightness, or the like may be measured.

A coupled arm light transmittance measurement system 400 may use mechanically linked arms 402a, 402b to support and move the light source 302 and the camera 314. The mechanical linkage insures that the light source 302 and the camera 314 remain aligned and stationary relative to each other. An actuator 404 may be used to move the mechanically linked arms 402a, 402b to enable light transmittance measurements at different locations on the substrate 310. Although not shown, a controller may be used to operate the coupled arm light transmittance measurement system 400. In particular, the controller may be used to direct one or more actuators (not shown) in moving the mechanically linked arms 402a, 402b.

In operation, the coupled arm light transmittance measurement system 400 may function much the same as the above described light transmittance measurement system 300 except the motion of the light source 302 and the camera 314 do not have to be coordinated since they are physically coupled together.

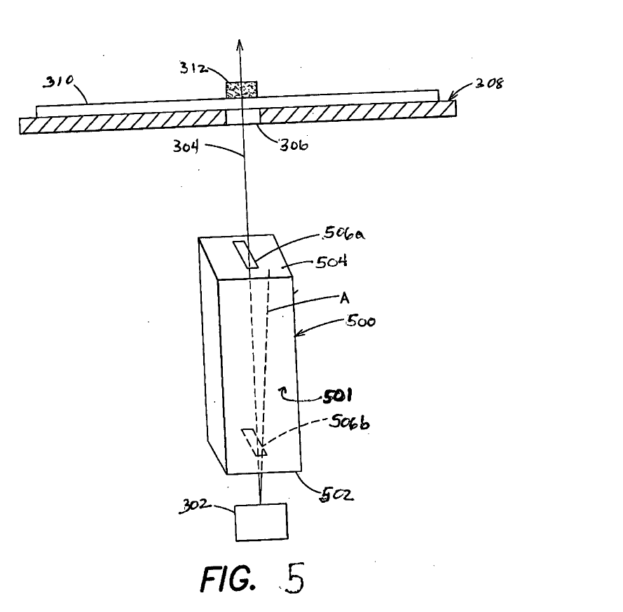

Turning to FIG. 5 a schematic illustration of an exemplary light absorbing channel 500 (“channel”) included with the light source 302 as the optical component 334 is provided. As will be further described below, the channel 500, as well as the integrating sphere 600 and colored filter component 700, is adapted to help improve the consistency of the intensity and color of the light used to measure transmittance. Improved consistency allows more accurate measurement results. Note that the channel 500 is not drawn to scale. Also note that while the channel 500 is depicted as a rectangular box, any other suitable shape and dimensions may be used, e.g., a cylinder. An interior 501 of the channel 500 may be coated or composed of a light-absorbing material. The channel 500 may include a first/input end 502 positioned opposite to a second/output end 504, wherein the first end 502 may be adapted to face the light source 302, and the second end 504 may be adapted to face the stage 308. Each of the first and second ends 502, 504, may include a first and second pinhole or slit 506a, 506b. The first and second pinholes or slits 506a, 506b may be any suitable size. The first and second pinholes 506a, 506b may be arranged in line with one another, and may allow a collimated portion of the light beam 304 to pass from the light source 302 through the channel 500 and then through the optical path 306 and through the filled pixel well 312 in the substrate 310. In other words, the first and second pinholes 306a, 306b may act to collimate or decrease dispersion of the light beam 304, such that only the portion of the light beam 304 that is transmitted on the path directly from the first pinhole 506b to the second pinhole 506a exits the channel 500 and reaches the substrate 308. The portion of the light beam 304 that does not pass directly from the first pinhole 506b through the second pinhole 506a, for example, the dotted light beam A, may be absorbed by the interior 501 of the channel 500 upon contact.

In alternative embodiments, the channel 500 may include more than one pinhole in the first end 502 and correspondingly, more than one pinhole in the second end 504, such that the pinholes in the first end 502 may correspond to, and be aligned with, the pinholes in the second end 504. Each set of pinholes may collimate the light for a particular filled pixel well.

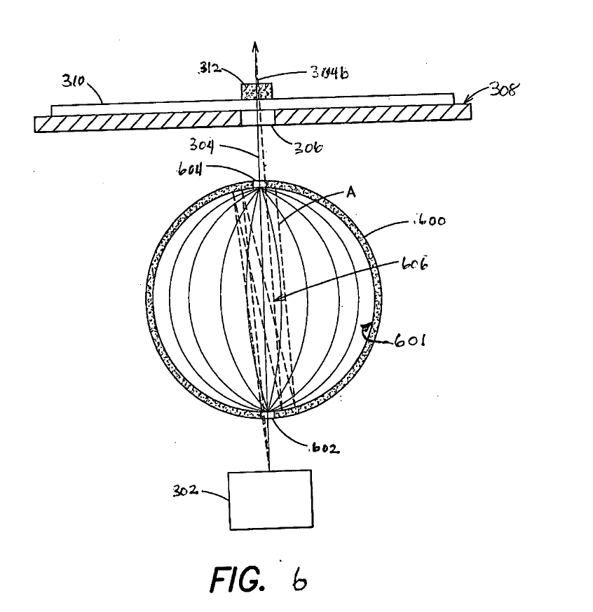

Turning to FIG. 6, a schematic illustration of a cross section of an exemplary integrating sphere 600 (“sphere”) included with the light source 302 as the optical component 334 is provided. Note that the sphere 600 is not drawn to scale. Any suitably dimensioned sphere may be used.

The interior of the sphere 600 may be a hollow cavity having an interior surface 601 coated for high diffuse reflectivity (e.g., mirrored, white, metallic, etc.). The shape of the cavity may be spherical or any other suitable shape. In alternate embodiments, the interior surface 601 may be made from a highly reflective material as opposed to being coated for high diffuse reflectivity, for example. The sphere 600 may include a first/input port 602 positioned opposite to a second/output port 604, wherein the input port 602 may be adapted to face the light source 302, and the output port 604 may be adapted to face the stage 308. Any other suitable quantity of input/output ports may be used.

In operation, the light beam 304 may be transmitted from the light source 302 through the input port 602 of the sphere 600 and into the sphere 600. Any portion of the light beam 304 that is incident upon any point on the interior surface 601 of the sphere 600 may be, by multiple scattering reflections, distributed equally to all other such points and the effects of the original direction of such light are minimized. In other words, as portions of the light beam 304 contact the reflective interior surfaces 601, in some embodiments they may either be infinitely reflected or may be repeatedly reflected until they exit the sphere 600 via the output port 604. For example, a portion of the light beam A contacts the reflective interior surface 601 and may be infinitely reflected within the sphere 600. As another example, a portion of light beam 304b may contact the interior surface 601 of the sphere 600, and then follow a path 606 until the light beam portion 304b exits the sphere 600 via output port 604. The sphere 600 may preserve the intensity of the light beam 304/304b such that the light beam 304/304b that exits the sphere 600 through the output port 604 may have a relatively uniform intensity over all points of the output port 604.

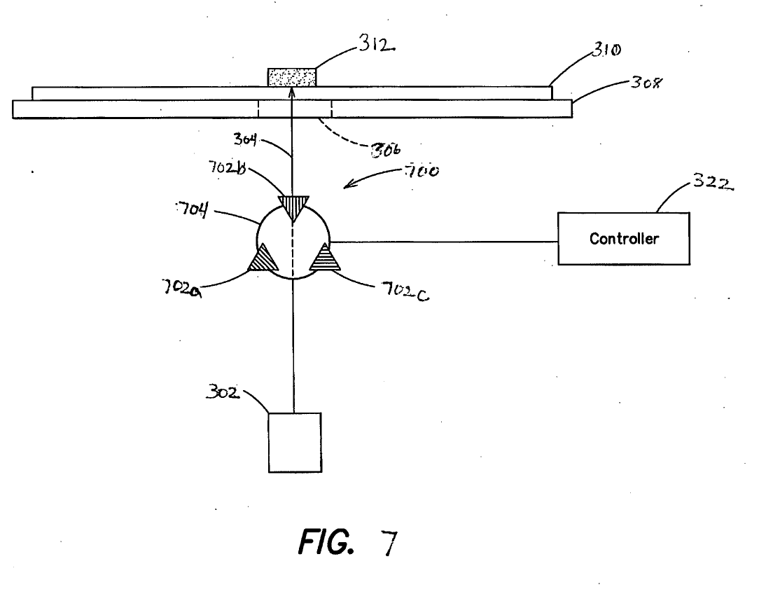

Turning to FIG. 7, a schematic illustration of an exemplary optical color filter component 700 (“CFC”) included with the light source 302 as the optical component 334 is provided, not drawn to scale. The CFC 700 may include one or more color filters 702a, 702b, 702c, corresponding to the colors (typically red, green and blue) of the deposited ink 312 to be measured. Other suitable colors or color intensities, as well as quantities of filters, may be used. Additionally, while the filters 702a, 702b, 702c are depicted herein as triangular shaped filters, any suitable shaped filter may be used. As is well known, colored filters absorb particular wavelengths and transmit the wavelengths they do not absorb. For example, a filter is yellow because it absorbs blue wavelengths (it's complementary color) and allows yellow light to pass through it. Therefore, when the light source 302 transmits a white light through a red filter 702b, for example, only red wavelengths are able to pass through the filter 702b and thereafter be transmitted thorough the deposited ink 312. The use of a red filter with a red ink deposit, for example, may allow light that is more uniform in intensity and color to be transmitted through the deposited ink 312, which may allow the controller 322 to more accurately determine the volume of deposited ink 312 and therefore more accurately determine whether the nozzles jetting the ink are properly calibrated.

In some embodiments, the color filters 702a, 702b, 702c may be coupled to a filter switching mechanism 704. The filter switching mechanism 704 may rotate or otherwise alternate the filters 702a, 702b, 702c, to selectively position an appropriate filter 702a, 702b, 702c in the path of the light beam 304. In some embodiments, the filter color through which the light beam 304 is transmitted may correspond to the color of the deposited ink 312. In some embodiments, the filter switching mechanism 704 may be coupled to the controller 322, wherein the controller 322 may be adapted to select, and thereafter position, a filter having a color corresponding to the color of the ink deposit 312, or other suitable color, in the path of the light beam 304 transmitted from the light source 302 to create a more uniform light beam 304 to transmit through the ink deposit 312. In some embodiments, the controller 322 may know or determine the color of the deposited ink 312 in the pixel well based on the position of the light source 302 relative to the substrate 310 (e.g., using a stored map or database of the display object on the substrate). In some embodiments, the controller 322 may use a sensor (e.g., camera 314) to determine the color of the deposited ink 312 in the filled pixel well to be measured.

The filter switching mechanism 704 may be any suitable switching mechanism. For example, as shown herein, the color filters 702a, 702b, 702c, may be coupled or affixed, in any suitable manner, to a wheel shaped structure that rotates to suitably position the appropriate color filter in the path of the light beam 304. In an alternative embodiment the CFC 700 may include a single color filter, and the filter switching mechanism 704 may be a robot, for example, that replaces the individual color filter (e.g., a red filter) with a different colored filter (e.g., a green filter), as needed. Other suitable switching mechanisms may be used (e.g., colored CCD cameras, or black and white cameras with filters). In some embodiments the filters 702a, 702b, 702c may be replaced by other filters, as needed (e.g., for repair, different colors, etc.).

In operation, ink may be deposited in a pixel well of the substrate 310 to form the flat panel display, and then a color filter may be selected. For example, if the ink 312 deposited in the pixel well is green, a green filter may be selected, as will be further described below. The color filter 702a may be positioned in the path of a light beam 304 and the filled pixel well 312. As described above, in some embodiments, the filter switching mechanism 704, which may be controlled by the controller 322, may appropriately position the selected filter 702a. The light source 302 may then transmit the light beam 304 through the color filter 702a and the ink filled pixel well 312. As described above, the controller 322 may send a signal to the light source 302 to transmit the light beam 304. As the white light of the light beam 304 is incident on the green filter, for example, only the green wavelengths are transmitted through the filter 702a and into the deposited green ink, as the other wavelengths may be absorbed by the filter 702a. In this way, the filtered wavelengths are more uniform in intensity and color, as they are all in the desired green range of wavelengths, for example, before they are transmitted through the deposited ink 312. The increased uniformity of the intensity and color of the wavelengths may provide for a more accurate determination of the amount of ink deposited in the pixel well. The filtered light beam that was transmitted through the ink filled pixel well may be measured. As described above, in some embodiments, the filtered light beam transmitted through the ink filled pixel well may be incident on a sensor or camera 314. The received light rays may be compared to a known quantity of emitted light rays, or a reference measurement, described below, to determine the amount of measured light transmittance. The controller 322, for example, may then compare the actual light transmitted to a look-up table, for example, or apply an algorithm to determine the amount of ink deposited in the pixel well.

In some embodiments, the filters 702a, 702b, 702c may be used to make a reference measurement for each of the filtered light colors, and for a white light reference during a calibration procedure. The appropriate data may then be correlated with the corresponding measurement of the corresponding colored ink. For example, the white light transmitted through the green filter 702a and the substrate 310 prior to an ink deposit, may form the baseline reference for determining the light transmittance through the green ink deposit. In a similar fashion, the red and blue filters 704b, 704c may form the baseline references for determining the light transmittance through the red and blue ink deposits. The reference values may be stored in the controller 322, for example. The measured transmittance prior to the ink deposit may be compared to the measured light transmittance subsequent to the ink deposit, and the amount of deposited ink may thereafter be algorithmically determined, for example.

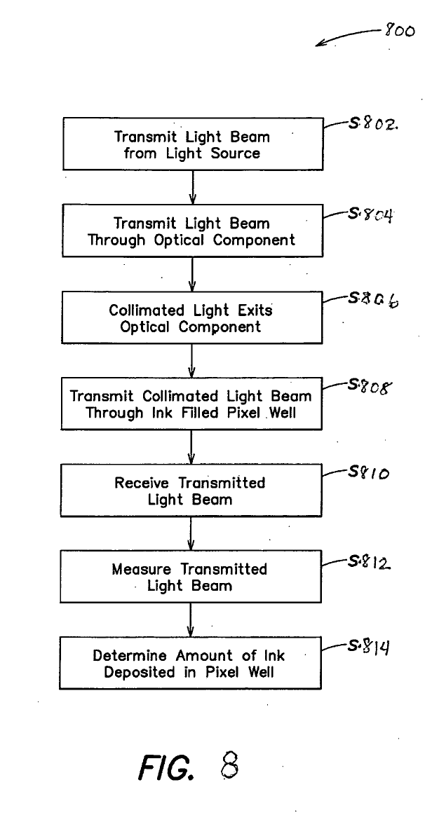

Turning to FIG. 8, a method 400 of measuring deposited ink is provided. In step S802 the light beam 304 is transmitted from the light source 302. In step S804, the transmitted light beam 304 passes through the optical component 334. As described above, the optical component 334 may be the channel 500, sphere 600, or CFC 700, for example. Other suitable optical components may be used. In step S806 the collimated light beam 304 exits the optical component 334. The collimated light beam 304 is transmitted through the ink filled pixel well in step S808. In step S810 the transmitted light beam is received by a camera or sensor. In step S812, the light transmittance of the received light beam is measured. Then in step S814, the controller, for example, may determine the amount of ink deposited in the pixel well based on the measured light transmittance. As described above, the ink volume determination may allow for an in situ adjustment or calibration of the nozzles jetting the ink, as needed.

The foregoing description discloses only exemplary embodiments of the invention. Modifications of the above which fall within the scope of the invention will be readily apparent to those of ordinary skill in the art. For instance, in some embodiments, multiple cameras may be used with a single light source to measure the deposited ink. Further, the present invention may also be applied to spacer formation, polarizer coating, and nanoparticle circuit forming.

Accordingly, while the present invention has been disclosed in connection with exemplary embodiments thereof, it should be understood that other embodiments may fall within the spirit and scope of the invention, as defined by the following claims.

The invention claimed is:

1. A system for manufacturing color filters for flat panel displays comprising:
an inkjet printing system including a stage for supporting and moving a substrate past inkjet print heads adapted to deposit ink in pixel wells on the substrate; and
a light transmittance measurement system including a sensor and a light source disposed on opposite sides of the substrate and adapted to determine the thickness of the ink deposited in the pixel wells on the substrate,
wherein the light source is adapted to move with the sensor to allow different pixel wells containing deposited ink to be measured.

2. The system of claim 1 wherein the stage includes at least one optical path adapted to allow light from the light source to pass through the deposited ink to the sensor.

3. The system of claim 1 wherein movement of the light source is coordinated with movement of the sensor such that the light source and the sensor remain aligned with each other.

4. The system of claim 1 wherein the light transmittance measurement system includes an optical component adapted to adjust a characteristic of light emitted by the light source.

5. The system of claim 4 wherein the optical component includes at least one of an integrating sphere, a light absorbing channel, and a color filter component.

6. A method of measuring an amount of ink deposited in a pixel well on a substrate comprising:
measuring light transmitted through ink deposited in a first pixel well using a light source and a sensor disposed on opposite sides of a substrate;
moving the sensor and the light source to a second pixel well without moving the sensor and the light source relative to each other; and
measuring light transmitted through the second pixel well.

7. The method of claim 6 further comprising measuring light transmitted through the substrate in an area without deposited ink.

8. The method of claim 6 wherein moving the sensor and the light source includes moving the sensor and the light source while maintaining alignment between the sensor and the light source.

9. The method of claim 6 wherein moving the sensor and the light source includes coupling the sensor and the light source together.

10. An apparatus for measuring an amount of ink deposited on a substrate comprising:
a sensor system adapted to measure light transmitted through ink deposited on a substrate; and
a coupling adapted to link a first part of the sensor system to a second part of the sensor system,
wherein the coupling is further adapted to maintain a fixed relative position between the first and second parts of the sensor system.

11. The apparatus of claim 10 wherein the first part of the sensor system includes a light source, and
the second part of the sensor system includes a camera.

12. The apparatus of claim 10 wherein the first part of the sensor system is disposed on a first side of the substrate and the second part of the sensor system is disposed on a second side of the substrate.

13. The apparatus of claim 10 wherein the first part of the sensor system is disposed on a first side of the substrate and the second part of the sensor system is disposed on the first side of the substrate.

14. The apparatus of claim 10 wherein a reflective surface is disposed on a second side of the substrate and adapted to reflect radiation from the first part of the sensor system to the second part of the sensor system.

15. An apparatus for measuring an amount of ink deposited in a pixel well on a substrate comprising:
an optical component, wherein the optical component is positioned between a light source and a substrate;
a sensor adapted to measure light transmitted from the light source, through the optical component and ink deposited in a pixel well.

16. The apparatus of claim 15 wherein the optical component includes a channel, wherein an interior of the channel is adapted to absorb light incident thereon.

17. The apparatus of claim 16 wherein the channel includes a first end facing the light source, and a second end facing the substrate, and
wherein the first end includes one or more entrance slits adapted to allow light into the channel and the second end includes one or more exit slits adapted to permit unabsorbed light to pass therethrough.

18. The apparatus of claim 15 wherein the optical component includes an integrating sphere, and
wherein an interior of the integrating sphere is coated for highly diffuse reflectivity.

19. The apparatus of claim 18 wherein the integrating sphere includes one or more entrance ports and one or more corresponding exit ports.

20. The apparatus of claim 15 wherein the optical component includes a color filter component comprising one or more color filters.

21. The apparatus of claim 20 wherein the color filters correspond to colors of the deposited ink.
